(19) United States
(12) Patent Application Publication
(10) Pub. No.: US 2008/0144098 A1
(43) Pub. Date: Jun. 19, 2008

(54) Data acquisition apparatus, data acquisition system and computer-readable storage medium

(76) Inventor: Atsushi Ishigaki, Tokyo (JP)

Correspondence Address: IPUSA, P.L.L.C, 1054 31ST STREET, N.W., Suite 400, Washington, DC, 20036, US

(21) Appl. No.: 12/000,218

(22) Filed: Dec. 11, 2007

(30) Foreign Application Priority Data
Dec. 12, 2006 (JP) 2006-334807

(51) Int. Cl. B41J 1/00

(52) U.S. Cl. 358/1.15

(57) ABSTRACT

A data acquisition apparatus is connectable via a network to a data management apparatus, and acquires data requested from the data management apparatus. The data acquisition apparatus has a storage to store the acquired data, and a control unit to send the acquired data that is stored in the storage and is requested by an external data acquisition request by adding transfer information to the acquired data that is sent. The control unit sends the acquired data in divisions if an amount of the acquired data stored in the storage exceeds a predetermined amount, by adding, as the transfer information, transfer start information to the acquired data sent in the divisions first, and adding transfer complete information to the acquired data that is sent last in the divisions or, sends the transfer complete information when there is no more unsent acquired data stored within the storage.

### BACKGROUND OF THE INVENTION

1. Field of the Invention

The present invention generally relates to data acquisition apparatuses, data acquisition systems and computer-readable storage media, and more particularly to a data acquisition apparatus for acquiring data such as log data, including a print log, a data acquisition system for appropriately and positively sending the data acquired at an acquisition source to a data management apparatus that manages the acquired data, and a computer-readable storage medium that stores a program for causing a computer to perform functions of the data acquisition apparatus or the data management apparatus. The present invention also relates to a data management apparatus that is provided in such a data acquisition system.

2. Description of the Related Art

Conventionally, there are systems for managing the amount of prints made for each user or department, and systems for performing the accounting with respect to each user or department depending on the amount of prints made with regard to the use of a printer, a scanner, a facsimile machine or apparatus, a copying machine or apparatus, and a Multi Function Peripheral (MFP) that integrates the functions of the printer, the scanner, the facsimile apparatus and the copying apparatus.

In one example of such a printing system, the number of prints output by the copy function is managed within the printer, and the number of prints output by the print function is managed by a print server. For example, such a printing system is proposed in a Japanese Laid-Open Patent Application No. 11-205498.

Recently, due to the popular use of network printers, a printing system in which a client apparatus such as a personal computer makes a print request directly with respect to the network printer is becoming a typical system with regard to the print function.

According to such a system structure in which the print request from the client server is not sent via the print server, a print log management server for managing print result information (hereinafter referred to as a print log) is provided in the network, so that the management of the number of prints made and the management of the accounting are centrally performed by the print log management server. For example, such a printing system is proposed in a Japanese Laid-Open Patent Application No. 11-242576.

The management of the number of prints made with regard to the print function and the facsimile function is realized by providing a counter (copy total counter, facsimile total counter, user-special counter, etc.) that counts the number of prints made within the printer or, by externally connecting the counter to the printer in the form of a card reader or the like. Generally, the number of prints output is managed based on a counter value of such a counter.

When the number of prints output is managed based on the counter value of the counter, the counter value is treated as a print log. Generally, a difference value between the counter value acquired by a previous acquisition and the counter value acquired by a present acquisition is calculated, and a difference value is recorded as the present print log.

According to the printing system proposed in a Japanese Laid-Open Patent Application No. 11-205498, a printer manages the number of prints output by a copy job that is requested by each user in correspondence with a copy ID of each user. In addition, a print server makes an output request of a print job that is requested from a client via a network, and manages the number of prints output by the print job in correspondence with a print ID of each user. A department management server acquires and totals the number of prints output by the copy jobs, which is managed by the printer, and also totals the number of prints output by the print jobs, which is managed by the print server, so as to centrally manage the number of prints output by the copy job and the number of prints output by the print job of each user.

According to a printing system proposed in a Japanese Laid-Open Patent Application No. 11-242576 (now Japanese Patent No. 2891981), when the client sends a print request file and a document file to an accounting server, the accounting server sends to the client a print permit file containing the amount of usable resources, such as the number of usable printing paper. In addition, the accounting server creates accounting information based on the amount of resources and stores the accounting information in an accounting information file. The client sends the print permit file to the printer before it sends the document file. The printer executes a print process only when the print permit file is received before the document file, so that the accounting information is centrally managed and the printing is controlled efficiently.

Furthermore, a Japanese Laid-Open Patent Application No. 2003-248576 proposes a peripheral equipment management system in which a peripheral equipment stores an ID of the user who used the peripheral equipment, print setting information (duplex or one-sided), and log information including information indicating the number of prints output in a log information storage. An information processing apparatus is connected to the peripheral equipment via a network, and tabulates the log information stored in the log information storage of the peripheral equipment. Based on the log information, the information processing apparatus calculates a difference between the number of prints used if the entire printing is made by duplex printing and the number of prints actually output, in order to display a reduction rate that is calculated from the difference. The purpose of this peripheral equipment management system is to easily see the extent to which the number of printing sheets can be reduced if the duplex printing and not the one-sided printing is employed, and to see the extent to which the number of printing sheets is reduced at the present.

On the other hand, a Japanese Laid-Open Patent Application No. 2004-110617 proposes another peripheral equipment management system in which a client generates job record information that indicates a record of the jobs executed, including an execution time of the jobs, and transfers the job record information to an external server. The server stores the job record information transferred from the client, and manages the job execution state of a peripheral equipment. In addition, the server calculates a time correction data indicating a difference between a client time that is measured at the client and a server time that is measured at the server, and uses the time correction data to correct the execution time included in the job record information into the server time, in order to manage the job execution times by a unified time without being affected by the error in the times measured at the client, and to correctly see the job execution state of the peripheral equipment.

Therefore, in the conventional systems, the data acquired by counting and the like at the acquiring-end apparatus, such as the printer, the peripheral equipment and the client, is sent in one operation to a separate managing-end apparatus that manages the number of prints and the like based on the acquired data. Alternatively, the managing-end apparatus acquires in one operation the data acquired at the acquiring-end apparatus.

However, because the data acquired at the acquiring-end apparatus is sent in one operation to the managing-end apparatus, there were demands to more appropriately and correctly send the acquired data to the managing-end apparatus.

In other words, when sending the acquiring data to the managing-end apparatus, a predetermined time-out time is normally provided to send the acquired data in one operation from the acquiring-end apparatus to the managing-end apparatus. For this reason, if the amount of data acquired at the acquiring-end apparatus becomes extremely large, the sending of the acquired data will not be completed within the time-out time. As a result, it is impossible to appropriately send the acquired data to the managing-end apparatus or, it is difficult to set the appropriate time-out time that would enable the sending of the acquired data from the acquiring-end apparatus to the managing-end apparatus to be completed within the time-out time. In addition, if the amount of data acquired at the acquiring-end apparatus becomes extremely large, a large load is applied on the acquiring-end apparatus to acquire and send the data. Furthermore, depending on the memory space restrictions and the like at the acquiring-end apparatus, it may not be possible to send the extremely large amount of acquired data to the managing-end apparatus in one operation.

### SUMMARY OF THE INVENTION

Accordingly, it is a general object of the present invention to provide a novel and useful data acquisition apparatus, data acquisition system and computer-readable storage medium, in which the problems described above are minimized.

Another and more specific object of the present invention is to provide a data acquisition apparatus, a data acquisition system and a computer-readable storage medium, which enable data acquired by the data acquisition apparatus to be sent appropriately and accurately to a data management apparatus.

According to one aspect of the present invention, a data acquisition apparatus is connectable via a network to a data management apparatus, acquires data requested from the data management apparatus, and includes a storage configured to store the acquired data, and a control unit configured to send the acquired data that is stored in the storage and is requested by an external data acquisition request by adding transfer information to the acquired data that is sent, wherein the control unit sends the acquired data in divisions if an amount of the acquired data stored in the storage exceeds a predetermined amount, by adding, as the transfer information, transfer start information to the acquired data sent in the divisions first, and adding transfer complete information to the acquired data that is sent last in the divisions or, sends the transfer complete information when there is no more unsent acquired data stored within the storage.

According to another aspect of the present invention, a data acquisition system has a data acquisition apparatus configured to acquire and store acquired data, including a storage to store the acquired data and a control unit to send the acquired data that is stored in the storage and is requested by a data acquisition request, by adding transfer information to the acquired data that is sent, and a data management apparatus configured to send the data acquisition request and manage the acquired data acquired from the data acquisition apparatus via a network, wherein the control unit of the data acquisition apparatus sends the acquired data in divisions if an amount of the acquired data stored in the storage exceeds a predetermined amount, by adding, as the transfer information, transfer start information to the acquired data sent in the divisions first, adding transfer complete information to the acquired data that is sent last in the divisions or, sends the transfer complete information when there is no more unsent acquired data stored within the storage, and adds, as the transfer information, transfer continue information to the acquired data sent in the divisions between the acquired data that are sent first and last.

According to still another aspect of the present invention, a computer-readable storage medium stores a program for causing a computer to function as a data acquisition apparatus that is connectable via a network to a data management apparatus and acquires data requested from the data management apparatus, and the program includes a procedure causing the computer to store the acquired data in a storage, and a control procedure causing the computer to send the acquired data that is stored in the storage and is requested by an external data acquisition request by adding transfer information to the acquired data that is sent, wherein the control procedure causes the computer to send the acquired data in divisions if an amount of the acquired data stored in the storage exceeds a predetermined amount, by adding, as the transfer information, transfer start information to the acquired data sent in the divisions first, and adding transfer complete information to the acquired data that is sent last in the divisions or, to send the transfer complete information when there is no more unsent acquired data stored within the storage.

Other objects and further features of the present invention will be apparent from the following detailed description when read in conjunction with the accompanying drawings.

### BRIEF DESCRIPTION OF THE DRAWINGS

FIG. 1 is a system block diagram showing a print log management system that is applied with a data acquisition apparatus, a data acquisition system and a computer-readable storage medium in one embodiment of the present invention;

FIG. 2 is a system block diagram showing a printer shown in FIG. 1 that is connected to a card reader;

FIG. 3 is a system block diagram showing an important part of the printer shown in FIG. 1;

FIG. 4 is a system block diagram showing an important part of an acquisition server shown in FIG. 1;

FIG. 5 is a system block diagram showing another print log management system that is applied with the data acquisition apparatus, the data acquisition system and the computer-readable storage medium in one embodiment of the present invention;

FIG. 6 is a sequence diagram for explaining a print log transfer process between the acquisition server and the printer shown in FIG. 1 in a normal state;

FIG. 7 is a sequence diagram for explaining a print log transfer process between the acquisition server and the printer shown in FIG. 1 in a state where a communication error is generated by a power failure of the printer;

FIG. 8 is a sequence diagram for explaining a print log transfer process between the acquisition server and the printer shown in FIG. 1 in a state where a communication error is generated by a power failure of the acquisition server;

FIG. 9 is a flow chart for explaining a print log acquisition control process of the acquisition server shown in FIG. 1; and

FIG. 10 is a flow chart for explaining a print log acquisition control process of the printer shown in FIG. 1.

### DESCRIPTION OF THE PREFERRED EMBODIMENTS

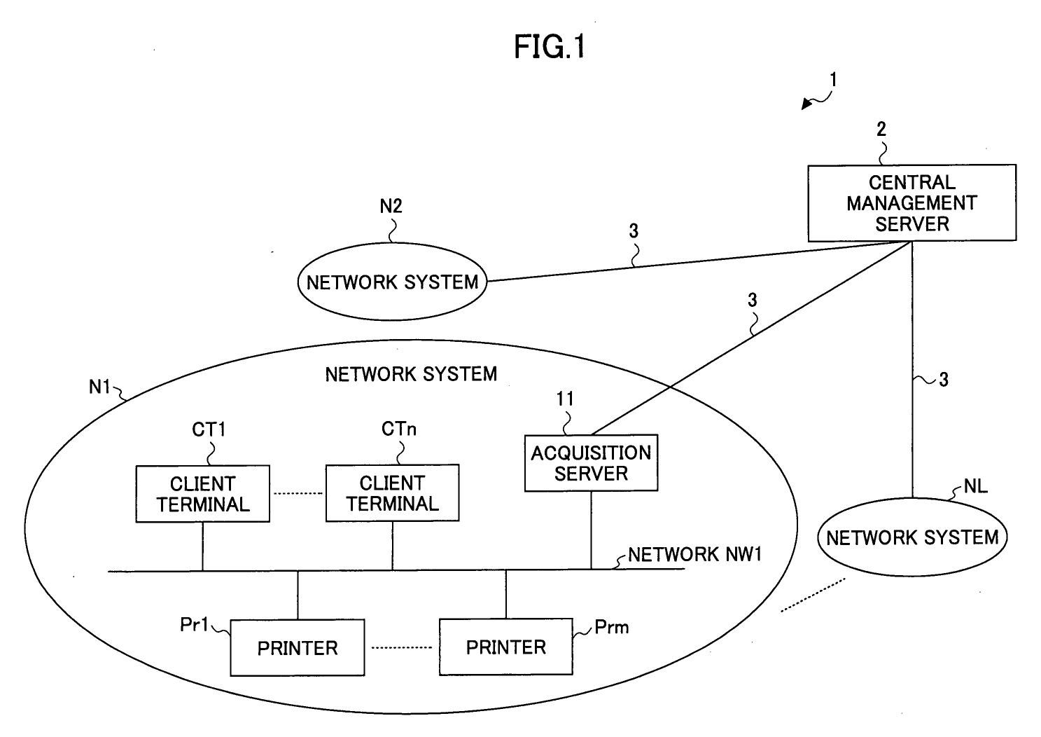

A description will be given of a data acquisition apparatus, a data acquisition system and a computer-readable storage medium in an embodiment of the present invention, by referring to FIGS. 1 through 10. FIG. 1 is a system block diagram showing a print log management system that is applied with the data acquisition apparatus, the data acquisition system and the computer-readable storage medium in one embodiment of the present invention.

In a print log management system 1 shown in FIG. 1, a central management server 2 is connected to a plurality of network systems N1 through NL via a communication line 3 such as the Internet, where L is an integer greater than or equal to 2. Each of the network systems N1 through NL is formed by a predetermined communication network such as a Local Area Network (LAN).

As shown in FIG. 1 for the network system N1, each of the network systems N1 through NL has a plurality of client terminals CT1 through CTn, a plurality of printers Pr1 through Prm, and an acquisition server 11 that are connected via a network (communication line) NW1 such as a LAN, where n and m are integers greater than or equal to 2. Each of the printers Pr1 through Prm functions as a data acquisition apparatus. The acquisition server 11 may function as a data management apparatus. Of course, it is not essential for the structures of the network systems N1 through NL to be identical.

Each of the printers Pr1 through Prm has at least a print function, but may additionally include one or more functions selected from a group consisting of a copy function, a facsimile function and a scanner function. Each of the printers Pr1 through Prm may be embedded with a data acquisition program that is read from a storage medium such as a Compact Disc (CD), a Magneto-Optical (MO) disc, a Compact Disc Read Only Memory (CD-ROM), a memory card and a flexible disc which stores the data acquisition program, so as to form the data acquisition apparatus of this embodiment of the present invention.

Each of the client terminals CT1 through CTn may be formed by a personal computer or the like. When a user (that is, an operator) specifies a document data created on an application that is implemented in one of the client terminals CT1 through CTn or, specifies a document data acquired from another one of the client terminals CT1 through CTn, and makes a print request by specifying one of the printers Pr1 through Prm, the document data is converted into a print data and sent to the specified one of the printers Pr1 through Prm as a print job together with print setting information.

In this state, the client terminals CT1 through CTn may generate and send to the acquisition server 11 a print log that includes information indicating what was printed, how many prints were made, which printer made the prints, how the prints were made and the like. But in order to send such a print log, it is necessary to install a dedicated software into the client terminals CT1 through CTn. For this reason, this embodiment does not use the print logs of the client terminals CT1 through CTn, and uses only the print logs (or log data) of the printers Pr1 through Prm.

Hence, in this embodiment, the printers Pr1 through Prm have a function of generating a print log (acquired data) related to each of the functions such as the print, copy, facsimile and scanner functions, and transferring the print log to the acquisition server 11.

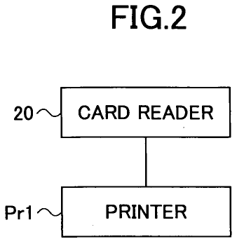

In addition, as shown in FIG. 2 for the printer Pr1, each of the printers Pr1 through Prm is provided with an externally connected card reader 20. FIG. 2 is a system block diagram showing the printer Pr1 shown in FIG. 1 that is connected to the card reader 20. After the user causes the card reader 20 to read a user card (not shown) that is recorded with a user ID or the like that can identify the user, the user operates at the printers Pr1 through Prm directly to utilize the copy function, the scanner function or the like. The print log is generated when the copy function, the scanner function or the like is utilized, and necessary information is acquired from the printers Pr1 through Prm and the card reader 20 and transferred to the acquisition server 11.

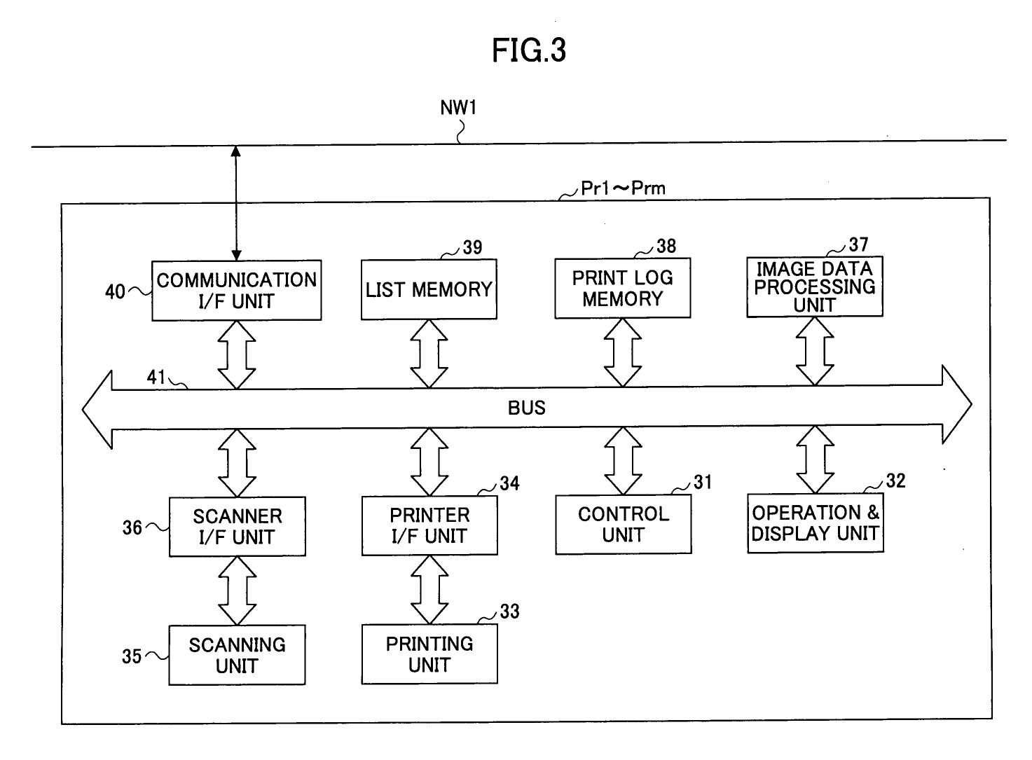

FIG. 3 is a system block diagram showing an important part of the printer shown in FIG. 1. Each of the printers Pr1 through Prm includes a control unit 31, an operation and display unit 32, a printing unit 33, a printer interface (I/F) unit 34, a scanning unit 35, a scanner interface (I/F) unit 36, an image data processing unit 37, a print log memory 38, a list memory 39, and a communication interface (I/F) unit 40. The control unit 31, the operation and display unit 32, the interface units 34, 36 and 40, the image data processing unit 37, and the memories 38 and 39 are connected via a bus 41.

The control unit 31 controls each part of the printer, and executes the operation process of the printer. In addition, the control unit 31 executes a sending process that includes acquiring the print log as the acquired data which will be described later, storing the print log in the print log memory 38, and sending the acquired and stored print log to the acquisition server 11. When sending the print log to the acquisition server 11, the control unit 31 executes a division sending process that sends the print log in divisions if the amount of data of the print log stored in the print log memory 38 exceeds a predetermined amount of data (predetermined amount) that is preset.

The communication interface unit 40 is connected to the network NW1, and includes an interface in conformance with the communication specifications of the network NW1. The communication interface unit 40 communicates with the client terminals CT1 through CTn and the acquisition server 11 that are connected to the network NW1, and exchanges various kinds of information by making exchanges such as receiving the print job from the client terminals CT1 through CTn and sending the print log to the acquisition server 11.

The list memory 39 is formed by a Random Access Memory (RAM) or the like, and stores a list (or table) of the print logs that are generated by the control unit 31 when sending the print logs that are stored within the print log memory 38 in divisions. The list memory 39 may be formed by a portion of a memory region forming the print log memory 38. In other words, the memory regions of the memories 38 and 39 may be formed by a single storage or, by a plurality of storages.

The print log memory 38 is formed by a RAM, a hard disc or the like, and forms an acquired data storage (or storage means). The print logs acquired by the control unit 31 are stored in the print log memory 38 by the control unit 31.

Under the control of the control unit 31, the image data processing unit 37 executes various data processings that are necessary to print on the printing unit 33 the print data received from the client terminals CT1 through CTn via the communication interface unit 40, and various processings that are necessary to print on the printing unit 33 or, to transfer to an apparatus via the network NW1 the image data of the document read by the scanning unit 35.

The scanning unit 35 scans the document in a main scan direction and a sub scan direction, so as to read the image of the document at a predetermined resolution, in the copy mode, the scan mode and the facsimile mode.

The scanning unit 35 is connected to the scanner interface unit 36. The scanner interface unit 36 provides an interface for connecting the control unit 31 and the scanning unit 35. The scanner interface unit 36 executes a process that includes transferring control information from the control unit 31 to the scanning unit 35, transferring the read image data from the scanning unit 35 to the control unit 31, and the like.

The printing unit 33 prints an image on a recording medium, such as paper, by a printing technique such as the electrophotography technique, based on the received image data, under the control of the control unit 31.

The printer interface unit 34 provides an interface for connecting the control unit 31 and the printing unit 33. The printer interface unit 34 executes a process that includes transferring control information from the control unit 31 to the printing unit 33, transferring a print mode, a print image data and the like from the control unit 31 to the printing unit 33, and the like.

The operation and display unit 32 includes an operation part and a display part such as a liquid crystal display. The operation part includes various kinds of operation keys such as a ten-key and a start key. Various instructions for executing a send operation, a copy operation, a facsimile operation and the like are input by the user from the operation part by manipulating the operation keys. The display part displays various kinds of information including the contents of the instructions input from the operation part and various information from the printers Pr1 through Prm to be notified to the user.

Although omitted in FIG. 3, a facsimile unit (not shown) is also provided in each of the printers Pr1 through Prm. This facsimile unit may be connected to the bus 41 via a facsimile interface unit (not shown) or, connected directly to the bus 41 if the communication interface unit includes the functions of the facsimile interface unit.

Each of the printers Pr1 through Prm operates the various parts thereof described above to execute various mode processes including a print mode process, a copy mode process, a scanner mode process, and a facsimile mode process. Every time each mode process is executed, the control unit 31 acquires the print log and stores the acquired print log into the print log memory 38. The print mode process prints and outputs the print from the printing unit 35 based on the print job that is received from the client terminals CT1 through CTn. The copy mode process reads the document that is set on the scanning unit 35 and prints and outputs the print from the printing unit 33. The scanner mode process reads the document that is set on the scanning unit 35 and sends the read image data to the client terminal CT1 through CTn and the like. The facsimile mode process receives a facsimile image data via a telephone line (not shown) or the like, prints and outputs the facsimile image from the printing unit 33, and reads the document (facsimile image) that is set on the scanning unit 35 and sends the read facsimile image data to an external apparatus via the telephone line or the like.

The acquisition server 11 in each of the network systems N1 through NL acquires and stores the print log related to the use of the printers Pr1 through Prm within the network system to which the acquisition server 11 belongs. As a method of acquiring the print log by the acquisition server 11, it is possible to employ the push-type method that makes a push from the printers Pr1 through Prm. But as described above, the acquisition server 11 of this embodiment sends the send request to each of the printers Pr1 through Prm, and each of the printers Pr1 through Prm sends the print log (acquired data) that is acquired in response to the send request.

The acquisition server 11 may be formed by a general-purpose computer. This general-purpose computer may be embedded with a data acquisition program that is read from a storage medium such as a CD, a MO disc, a CD-ROM, a memory card and a flexible disc which stores the data acquisition program, in order to form the data management apparatus of this embodiment of the present invention.

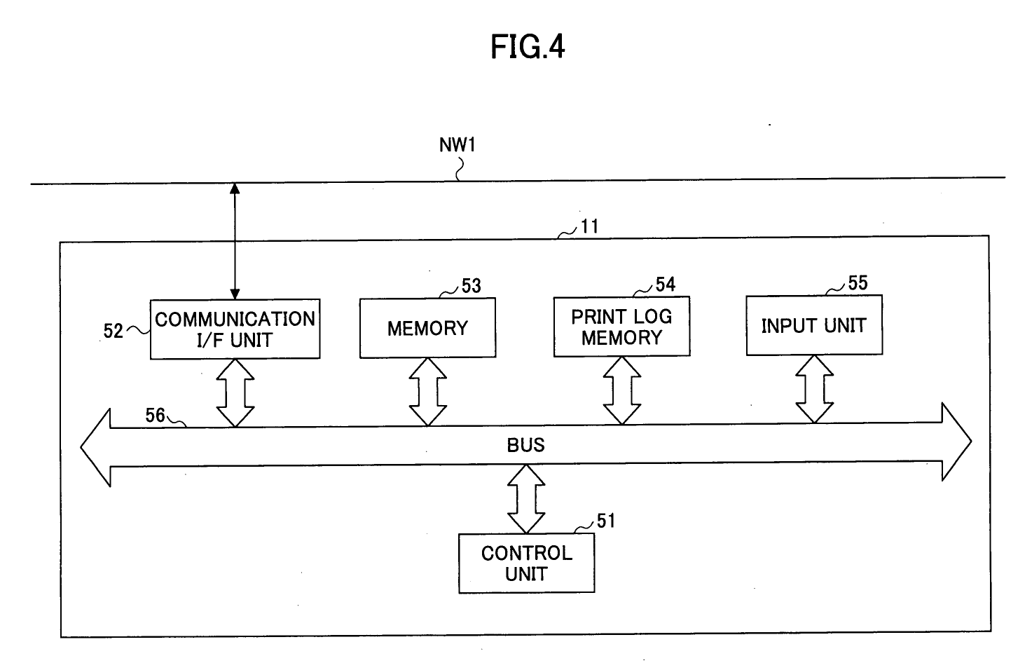

FIG. 4 is a system block diagram showing an important part of the acquisition server 11 shown in FIG. 1. As shown in FIG. 4, the acquisition server 11 includes a control unit 51, a communication interface (I/F) unit 52, a memory 53, a print log memory 54 and an input unit 55 that are connected via a bus 56.

The control unit 51 controls each part of the acquisition server 11 to execute a print log management process, and also controls each part of the acquisition server 11 based on the embedded or installed data acquisition program to execute a print log acquisition process, particularly a divided acquisition process.

The communication interface unit 52 is connected to the network NW1, and includes an interface in conformance with the communication specifications of the network NW1. The communication interface unit 52 communicates with the client terminals CT1 through CTn and the printers Pr1 through Prm that are connected to the network NW1, and exchanges various kinds of information by making exchanges, particularly the acquisition of the print logs.

The memory 53 is formed by a RAM or the like, and forms a temporary storage (or storage means). Under the control of the control unit 51, every time a divided acquisition (divided sending) of the print logs from the printers Pr1 through Prm is made, the memory 53 temporarily stores the print logs that are received from the printers Pr1 through Prm for every divided sending of the divided acquisition. The memory 53 may be formed by a portion of a memory region forming the print log memory 54. In other words, the memory regions of the memories 53 and 54 may be formed by a single storage or, by a plurality of storages.

The print log memory 54 is formed by a RAM, a hard disc or the like, and stores the print logs received from the printers Pr1 through Prm under the control of the control unit 51.

The input unit 55 is formed by a keyboard, a mouse or the like, and is manipulated by the user when instructing various operations, including the setting of the acquisition timing for the print logs.

When the send request for the print logs is received from the central management server 2, the acquisition server 11 of each of the network systems N1 through NL sends the print logs (acquired data) stored therein to the central management server 2. The divided sending may also be employed when sending the print logs to the central management server 2. When the acquisition server 11 sends the print logs to the central management server 2 by the divided sending, the memory 53 is used to store a list of the print logs, similarly to the list memory 39 of each of the printers Pr1 through Prm. Hence, the central management server 2 may function as a data management apparatus.

The central management server 2 may be formed by a general-purpose computer. This general-purpose computer may be embedded with a data acquisition program that is read from a storage medium such as a CD, a MO disc, a CD-ROM, a memory card and a flexible disc which stores the data acquisition program, in order to form the data management apparatus of this embodiment of the present invention. The central management server 2 acquires and stores the print logs from the acquisition server 11 of each of the network systems N1 through NL, and manages the utilization state and the like of the printers Pr1 through Prm that are the managing targets of each of the network systems N1 through NL, based on the stored print logs. Although not shown, the central management server 2 includes a memory for temporarily storing the print logs that are received in divisions by the divided sending, and a print log memory for storing the print logs, as elements required to acquire and store the print logs.

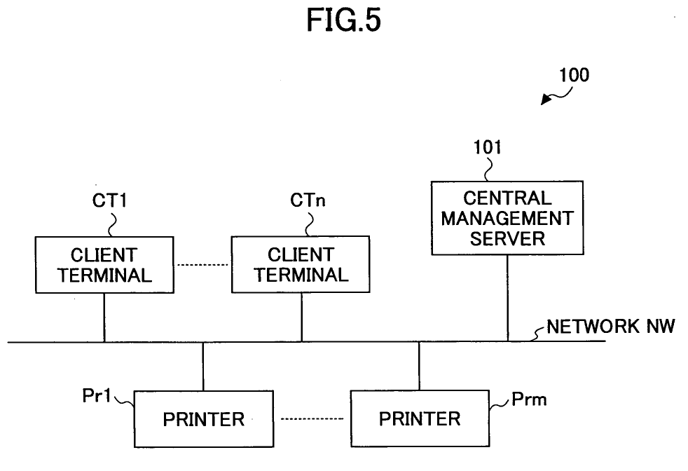

In the print log management system 1 shown in FIG. 1, the plurality of network systems N1 through NL each having the acquisition server 11 are connected to the central management server 2. However, the print log management system to which this embodiment or the present invention may be applied is not limited to systems having the structure shown in FIG. 1, and it is possible to employ a structure shown in FIG. 5, for example.

FIG. 5 is a system block diagram showing another print log management system that is applied with the data acquisition apparatus, the data acquisition system and the computer-readable storage medium. In the print log management system 100 shown in FIG. 5, a plurality of client terminals CT1 through CTn, a plurality of printers Pr1 through Prm, and a central management server 101 are connected to a network NW such as a LAN. In this case, the central management server 101 acquires and stores the print logs from the client terminals CT1 through CTn and the printers Pr1 through Prm, and manages each of the printers Pr1 through Prm.

Next, a more detailed description will be given of the operation of this embodiment, for the case where the print log management system 1 having the structure shown in FIG. 1 is employed.

In the print log management system 1 of this embodiment, the print logs acquired by the printers Pr1 through Prm are stored in the print log memory 38, and the print logs are appropriately and accurately sent in divisions if necessary in response to the send request from the acquisition server 11.

In other words, in the print log management system 1, the print logs are created and stored in the print log memory 38 every time one of the various kinds of mode processes, such as the print mode process or the copy mode process, is executed by the printers Pr1 through Prm.

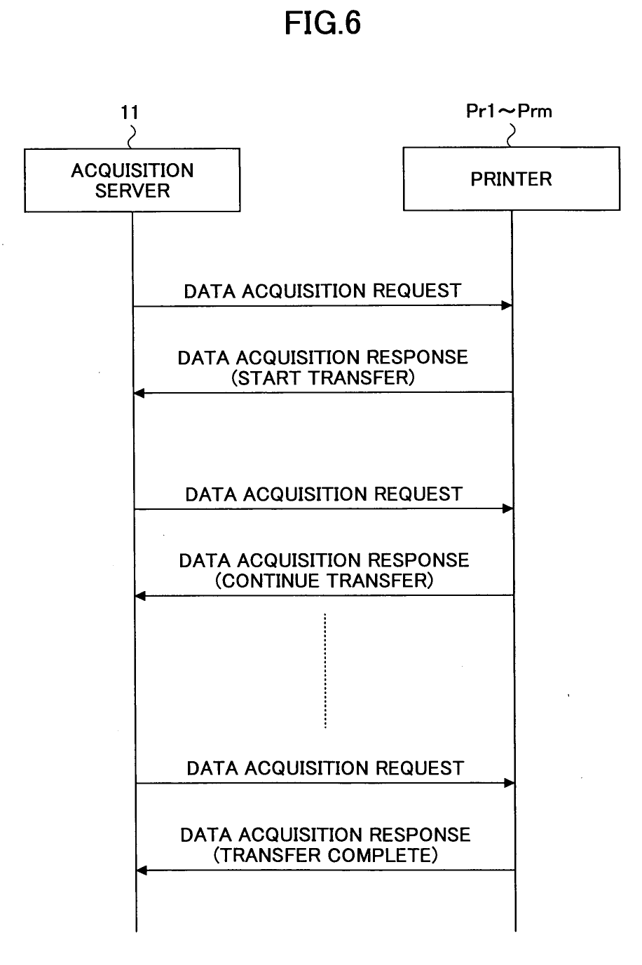

When the predetermined data acquisition timing that has been preset comes, the acquisition server 11 sends a data acquisition request (or send request) to each of the printers Pr1 through Prm that are managed by the acquisition server 11, as shown in FIG. 6. FIG. 6 is a sequence diagram for explaining a print log transfer process between the acquisition server 11 and each of the printers Pr1 through Prm shown in FIG. 1 in a normal state. When the send request is received from the acquisition server 11, each of the printers Pr1 through Prm sends a predetermined amount (divided sending amount) of the print logs that are stored in the print log memory 38, and also sends a data acquisition response (or data acquisition acknowledge) that is added with transfer start information, to the acquisition server 11.

When the data acquisition response added with the transfer start information is returned from the printers Pr1 through Prm, the acquisition server 11 temporarily stores the print logs, and again sends a data acquisition request (or send request) to the printers Pr1 through Prm. When the send request is again received, each of the printers Pr1 through Prm checks whether or not unsent print logs remain stored within the print log memory 38. If the unsent print logs remain stored within the print log memory 38, each of the printers Pr1 through Prm sends a predetermined amount (divided sending amount) of the remaining print logs that are stored in the print log memory 38, and also sends a data acquisition response that is added with transfer continue information, to the acquisition server 11.

When the data acquisition response added with the transfer continue information is returned from the printers Pr1 through Prm, the acquisition server 11 temporarily stores the print logs in the memory 53, and again sends a data acquisition request (or send request) to the printers Pr1 through Prm. When the send request is again received, each of the printers Pr1 through Prm checks whether or not unsent print logs remain stored within the print log memory 38. If no unsent print logs remain stored within the print log memory 38, each of the printers Pr1 through Prm sends a data acquisition response that is added with transfer complete information to the acquisition server 11.

When the data acquisition response added with the transfer complete information is returned from the printers Pr1 through Prm, the acquisition server 11 commits the print logs that are temporarily stored in the memory 53, and stores the print logs in the print log memory 54.

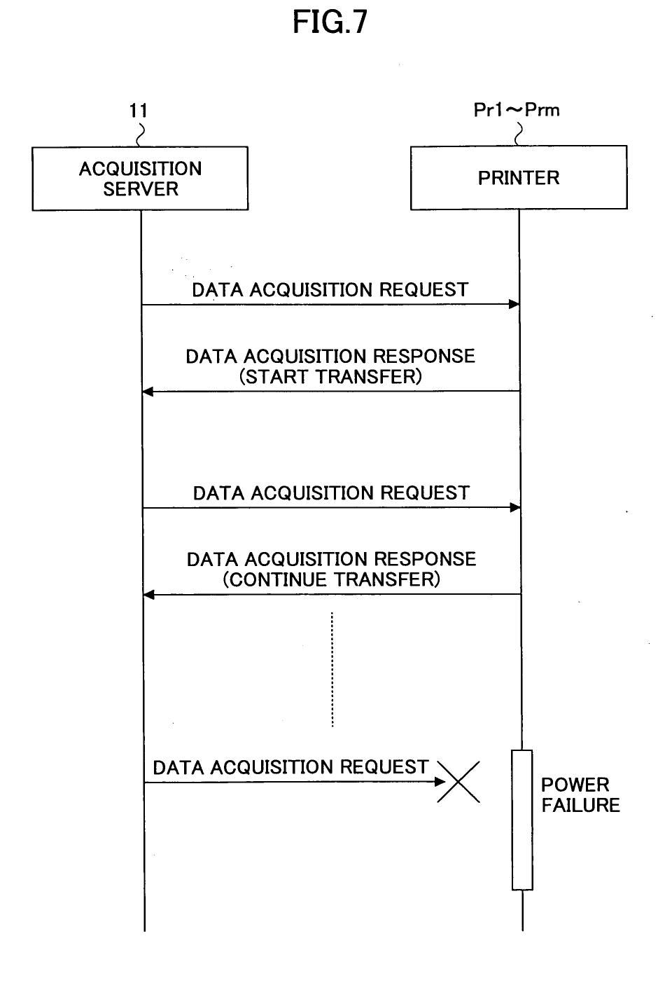

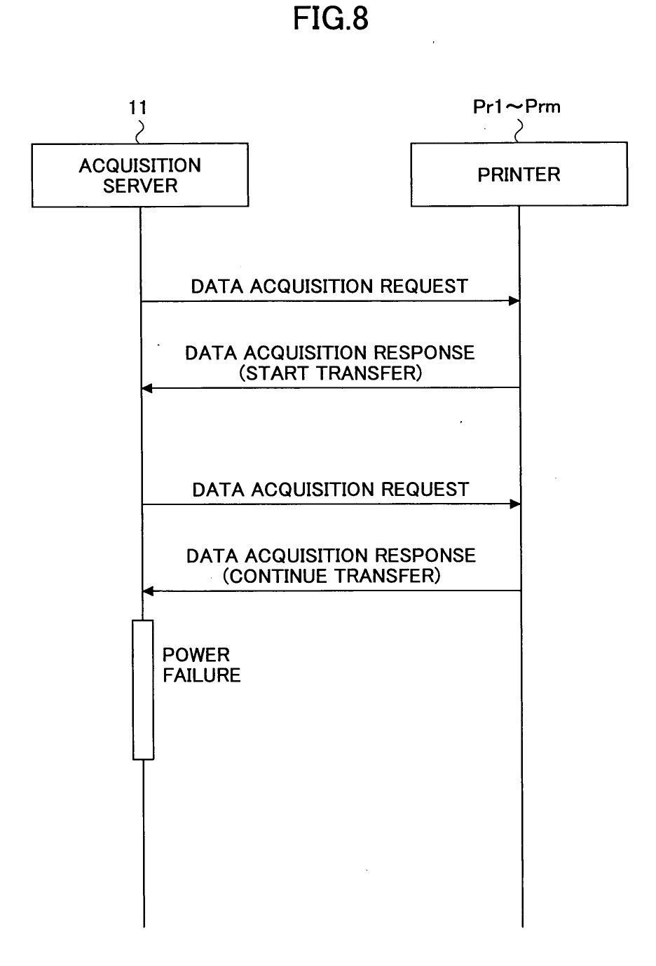

However, during the transfer of the print logs, a transfer error may be generated by a power failure or the like at the printers Pr1 through Prm as shown in FIG. 7 or, a transfer error may be generated by a power failure or the like at the acquisition server 11 as shown in FIG. 8. FIG. 7 is a sequence diagram for explaining a print log transfer process between the acquisition server 11 and the printer shown in FIG. 1 in a state where a communication error is generated by the power failure of the printer. FIG. 8 is a sequence diagram for explaining a print log transfer process between the acquisition server 11 and the printer shown in FIG. 1 in a state where a communication error is generated by the power failure of the acquisition server 11.

In the case shown in FIG. 7, for example, after the acquisition server 11 issues the data acquisition request, a connection to the network NW1 is temporarily impossible due to the power failure or the like at the printers Pr1 through Prm. In this case, since the power failure or the like is generated at the printers Pr1 through Prm, the power of the printers Pr1 through Prm is thereafter turned ON and the print logs are sent from the start when the data acquisition request is received from the acquisition server 11.

In this state, if the acquisition server 11 stores the incomplete print logs that were sent in divisions and if the acquisition server 11 were to continue storing the print logs that are received after the power failure or the like of the printers Pr1 through Prm is restored, an inconsistency would be generated in the print logs that are stored in the acquisition server 11.

But in the print log management system 1 of this embodiment, the acquisition server 11 is provided with the memory 53 for temporarily storing the print logs. If the transfer information added to the data acquisition response from the printers Pr1 through Prm is the transfer start information, the acquisition server 11 clears the memory 53 and starts to temporarily store the print logs that are received into the memory 53. If the transfer information added to the data acquisition response received thereafter from the printers Pr1 through Prm by the print log transfer is the transfer continue information, the acquisition server 11 temporarily stores the print logs into the memory 53. Further, if the transfer information added to the data acquisition response received from the printers Pr1 through Prm by the print log transfer becomes the transfer complete information, the acquisition server 11 commits the print logs that are temporarily stored in the memory 53, and stores the committed print logs into the print log memory 54. As a result, it is possible to prevent an inconsistency in the print logs that are stored in the acquisition server 11 by storing the committed print logs in the print log memory 54, and the accuracy of the stored print logs is improved. The committed print logs are obtained by making tentative changes in the print logs permanent, that is, by committing the print logs.

On the other hand, in the case shown in FIG. 8, the print log acquisition process is interrupted by the power failure or the like at the acquisition server 11 during the print log acquisition. In this case, the acquisition server 11 cannot issue a data acquisition request, and after the power failure or the like is restored, the acquisition server 11 discards the print logs that were being acquired, and again issues a data acquisition request.

In this state, if the printers Pr1 through Prm do not receive the data acquisition request within a predetermined wait time during the sending of the print logs in divisions, the printers Pr1 through Prm may be designed to discard the print logs that were being transferred and to start sending the print logs from the start when the data acquisition request is again received from the acquisition server 11, in order not to generate an inconsistency in the print logs. However, if the acquisition server 11 is restored and the data acquisition request is issued before the predetermined wait time elapses, the printers Pr1 through Prm would continue the transfer of the print logs in divisions without discarding the print logs that were being transferred. Consequently, an inconsistency of the print logs would occur between the acquisition server 11 and the printers Pr1 through Prm.

For this reason, in the print log management system 1 of this embodiment, when the acquisition server 11 issues the data acquisition request after the error, such as the power failure, of the acquisition server 11 is generated, the acquisition server 11 issues a data acquisition request that is added with start data request information that requests the print logs to be sent from the start, in order to prevent the inconsistency of the print logs.

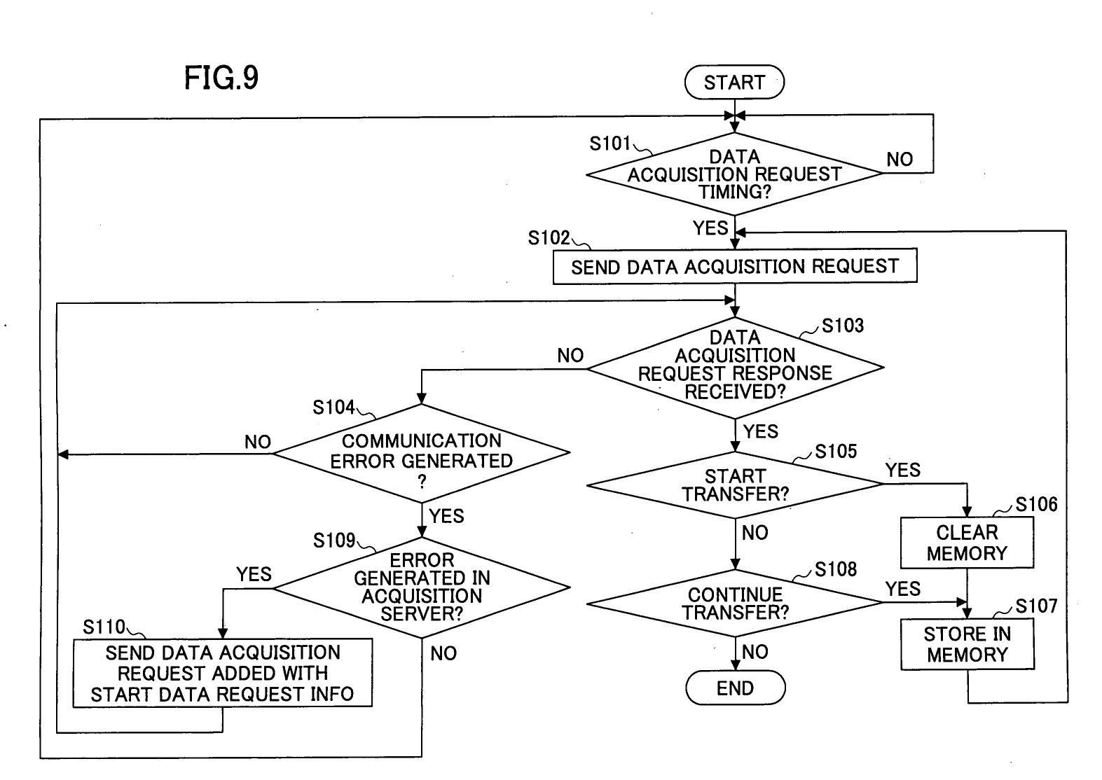

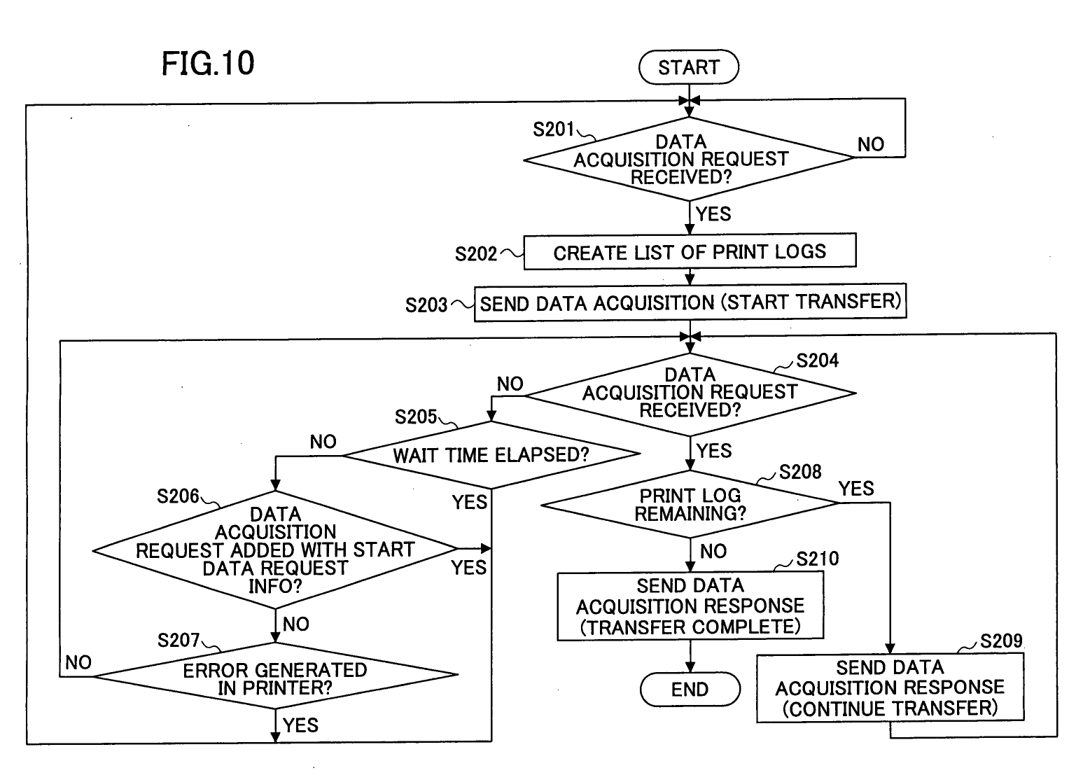

FIG. 9 is a flow chart for explaining a print log acquisition control process of the acquisition server 11 shown in FIG. 1, and FIG. 10 is a flow chart for explaining a print log acquisition control process of the printer shown in FIG. 1.

In the acquisition server 11 of the print log management system 1, if the data acquisition request timing comes (step S101) in FIG. 9, the control unit 51 sends the data acquisition request to each of the printers Pr1 through Prm via the communication interface unit 40 and the network NW1 (step S102), and the control unit 51 checks whether or not the data acquisition response is received from the printers Pr1 through Prm (step S103).

On the other hand, in the printers Pr1 through Prm, the control unit 31 checks whether or not the data acquisition request from the acquisition server 11 is received via the communication interface unit 52 (step S201) in FIG. 10. If the data acquisition request is received, the control unit 31 creates a list of the print logs stored in the print log memory 38 and stores the list in the list memory 39 (step S202). Based on this list, the control unit 31 sends a data acquisition response to the acquisition server 11 via the communication interface unit 40 and the network NW1 by adding the transfer start information to a predetermined divided sending amount of the print logs stored in the print log memory 38 (step S203). After sending the data acquisition response that is added with the transfer start information, the printers Pr1 through Prm checks whether or not a data acquisition request is again received (step S204).

If no data acquisition response is received in the step S103 shown in FIG. 9, the control unit 51 of the acquisition server 11 checks whether or not a communication error is generated (step S104). If no communication error is generated, the process returns to the step S103, and the acquisition server 11 checks whether or not the data acquisition response is received (step S103). If the data acquisition response is received in the step S103, the control unit 51 checks whether or not the transfer start information is added to the data acquisition response that is received (step S105). Since the transfer of the first print log is started and the transfer information is added to the data acquisition response in this case, the control unit 51 clears the memory 53 (step S106), and thereafter stores the received print logs in the memory 53 (step S107). After storing the print logs in the memory 53, the process of the control unit 51 returns to the step S102, and the control unit 51 sends the next data acquisition request to the printers Pr1 through Prm at a predetermined timing (step S102). Further, the control unit 51 checks whether or not the data acquisition response is received (step S103).

In the printers Pr1 through Prm, if the next data acquisition request is not received in the step S204, the control unit 31 checks whether or not a predetermined wait time has elapsed (step S205). If the predetermined wait time has not elapsed, the control unit 31 checks whether or not the data acquisition request added with the start data request information (or request) is received (step S206). If the data acquisition request that is added with the start data request information is not received in the step S206, the control unit 31 checks whether or not an error such as the power failure is generated in the printers Pr1 through Prm (step S207). If no error is generated, the process returns to the step S204, and the control unit 31 checks whether or not the data acquisition request is received (step S204).

If the data acquisition request is received in the step S204, the control unit 31 of the printers Pr1 through Prm checks whether or not unsent print logs that are to be sent remain stored within the print log memory 54 (step S208). If the unsent print logs remain stored within the print log memory 54, the control unit 31 sends the data acquisition response to the acquisition server 11 via the communication interface unit 40 and the network NW1 by adding the transfer continue information to the divided sending amount of the remaining print logs (step S209). Thereafter, the process returns to the step S204, and the control unit 31 checks whether or not the next data acquisition request is received (step S204).

When the acquisition server 11 receives the data acquisition response in the step S103, the control unit 51 checks whether or not the transfer start information is added to the data acquisition response (step S105). Since this is the second transfer of the print logs in divisions and the transfer information added to the data acquisition response is not the transfer start information, the control unit 51 checks whether or not the added transfer information is the transfer continue information (step S108). Because the added transfer information is the transfer continue information, the control unit 51 temporarily stores the print logs in the memory 53 (step S107). After temporarily storing the print logs in the memory 53, the process returns to the step S102, and the control unit 51 sends the next data acquisition request to the printers Pr1 through Prm at a predetermined timing (step S102). Further, the control unit 51 checks whether or not the data acquisition response is received (step S103).

In the printers Pr1 through Prm, if the data acquisition request is received in the step S204, the control unit 31 checks whether or not unsent print logs that are to be sent remain stored within the print log memory 54 (step S208). If the unsent print logs remain stored within the print log memory 54, the control unit 31 sends the data acquisition response to the acquisition server 11 via the communication interface unit 40 and the network NW1 by adding the transfer continue information to the divided sending amount of the remaining print logs (step S209), as described above. Thereafter, the process returns to the step S204, and the control unit 31 checks whether or not the next data acquisition request is received (step S204). If no unsent print logs that are to be sent remain stored within the print log memory 54 in the step S208, the control unit 31 sends the data acquisition response that is added with the transfer complete information to the acquisition server 11 via the communication interface unit 40 and the network NW1 (step S210), and the process ends.

The acquisition server 11 receives the data acquisition response in the step S103, and the control unit 51 judges that the transfer of the print logs is completed and the process ends, if the transfer information added to the received data acquisition response is not the transfer start information (step S105), is not the transfer continue information (step S108), but is the transfer complete information (NO in step S108).

In the acquisition server 11, if the communication error is generated in the step S104 while waiting for the receipt of the data acquisition response, the control unit 51 judges whether or not the error is generated by the power failure or the like of the acquisition server 11 itself (step S109) as shown in FIG. 8. If the communication error is not generated in the acquisition server 11, the control unit 51 judges that the error is generated by the power failure or the like of the printers Pr1 through Prm as shown in FIG. 7, and the process returns to the step S101 to wait for the next data acquisition request and to carry out processes similar to those described above.

In addition, if the error is generated in the acquisition server 11 in the step S109, the control unit 51 sends the data acquisition request that is added with the start data request information (step S110), and the process returns to the step S103 to check whether or not the data acquisition request is received (step S103).

Therefore, if the printers Pr1 through Prm do not receive the data acquisition request within a predetermined wait time during the sending of the print logs in divisions, and the printers Pr1 through Prm are designed to discard the print logs that were being transferred and to start sending the print logs from the start when the data acquisition request is again received from the acquisition server 11, no inconsistency will be generated in the print logs. However, if the acquisition server 11 is restored and the data acquisition request is issued before the predetermined wait time elapses, the printers Pr1 through Prm will continue the transfer of the print logs in divisions without discarding the print logs that were being transferred. Consequently, an inconsistency of the print logs will occur between the acquisition server 11 and the printers Pr1 through Prm. But when the acquisition server 11 issues the data acquisition request after the error such as the power failure of the acquisition server 11 is generated, and the acquisition server 11 is designed to issue the data acquisition request that is added with start data request information that requests the print logs to be sent from the start, it is possible to prevent the inconsistency of the print logs.

In addition, in the printers Pr1 through Prm, if an error such as the power failure is generated in the printers Pr1 through Prm during the transfer of the print logs in the step S207 as shown in FIG. 7, the process returns to the step S201 in order to carry out the process in a similar manner to that as described above from the initial state. In other words, if the error, such as the power failure, is generated in the printers Pr1 through Prm during the transfer of the print logs, and next the data acquisition request is received, the transfer of the print logs is restarted (or resumed) from the start instead of continuing from where the transfer of the print logs was discontinued due to the error.

Furthermore, in the printers Pr1 through Prm, if the predetermined wait time elapses in the step S205 without receiving the data acquisition request in the step S204 due to the power failure or the like of the acquisition server 11, as shown in FIG. 8, the process returns to the step S201 in order to carry out the process in a similar manner to that described above from the initial state. In other words, if the error such as the power failure is generated in the printers Pr1 through Prm during the transfer of the print logs, and next the data acquisition request is received, the transfer of the print logs is restarted from the start instead of continuing from where the transfer of the print logs was discontinued due to the error.

Moreover, in the printers Pr1 through Prm, if the predetermined wait time does not elapse in the step S205 but the data acquisition request that is added with the start data request information is received in the step S206, the process returns to the step S201 in order to carry out the process in a similar manner to that described above from the initial state. In other words, if the error such as the power failure is generated in the printers Pr1 through Prm during the transfer of the print logs, and next the data acquisition request is received, the transfer of the print logs is restarted from the start instead of continuing from where the transfer of the print logs was discontinued due to the error.

Accordingly, as shown in FIG. 7, after the acquisition server 11 issues the data acquisition request, if a connection to the network NW1 is temporarily impossible due to the power failure or the like at the printers Pr1 through Prm, because the power failure or the like is generated at the printers Pr1 through Prm, the power of the printers Pr1 through Prm is thereafter turned ON and the print logs are sent from the start when the data acquisition request is received from the acquisition server 11. In this state, if the acquisition server 11 were to store the incomplete print logs that were sent in divisions and if the acquisition server 11 were to continue storing the print logs that are received after the power failure or the like of the printers Pr1 through Prm is restored, an inconsistency would be generated in the print logs that are stored in the acquisition server 11.

But if the acquisition server 11 is provided with the memory 53 for temporarily storing the print logs, and the transfer information added to the data acquisition response from the printers Pr1 through Prm is the transfer start information, the acquisition server 11 clears the memory 53 and starts to temporarily store the print logs that are received into the memory 53. If the transfer information added to the data acquisition response received thereafter from the printers Pr1 through Prm by the print log transfer is the transfer continue information, the acquisition server 11 temporarily stores the print logs into the memory 53. Further, if the transfer information added to the data acquisition response received from the printers Pr1 through Prm by the print log transfer becomes the transfer complete information, the acquisition server 11 commits the print logs that are temporarily stored in the memory 53, and stores the committed print logs into the print log memory 54. As a result, it is possible to prevent an inconsistency in the print logs that are stored in the acquisition server 11 by storing the committed print logs in the print log memory 54, and the accuracy of the stored print logs is improved.

As described above, when sending the print logs in divisions, the transfer start information is added to the print log that is sent in divisions first, the transfer continue information is added to the print logs that are sent thereafter in divisions, and the transfer complete information is sent when there is no more unsent transfer logs to be sent in divisions. However, the method of transferring the transfer information such as the transfer start information, the transfer continue information and the transfer complete information is not limited to that described above. For example, when sending the print logs in divisions, the transfer start information may be added to the print log that is sent in divisions first, the transfer continue information may be added to the print logs that are sent thereafter in divisions, and the transfer complete information may be added to the print logs that are sent in divisions last.

Therefore, in the print log management system 1 of this embodiment, the acquired data sending process sends the print logs (or acquired data) that are acquired by the printers Pr1 through Prm and stored in the print log memory 38 to the acquisition server 11 via the network NW1. If the amount of the target print logs to be sent exceeds a predetermined amount when executing the acquired data sending process, the target print logs are sent in divisions, in units of a predetermined amount, from the printers Pr1 through Prm to the acquisition server 11. When sending the target print logs in divisions, the transfer start information is added to the print log that is sent in divisions first, the transfer continue information is added to the print logs that are sent thereafter in divisions, and the transfer complete information is sent when there is no more unsent transfer logs to be sent in divisions or, the transfer complete information is added to the print logs that are sent in divisions last.

Accordingly, it is possible to set an appropriate time-out time for the print log (or acquired data) sending process, and set an appropriate amount with which the print logs are to be sent in divisions. As a result, it is possible to distribute the load on the acquisition server 11 by sending an extremely large amount of print logs in divisions, and to appropriately and positively send the extremely large amount of print logs.

In addition, in the print log management system 1 of this embodiment, the acquisition server 11 includes the memory 53 for temporarily storing the print logs that are sent from the printers Pr1 through Prm. If the print logs that are sent in divisions from the printers Pr1 through Prm and the acquired data received at the acquisition server 11 is added with the transfer start information, the memory 53 is cleared before temporarily storing the acquired data. If the acquired data received at the acquisition server 11 is added with the transfer continue information, the acquired data is temporarily stored in the memory 53. If the acquired data received at the acquisition server 11 is added with the transfer complete information, the acquired data is temporarily stored in the memory 53 and the acquired data stored in the memory 53 is committed. Alternatively, if only the transfer information is received at the acquisition server 11, the acquired data stored in the memory 53 is committed.

Accordingly, even if an error is generated during the sending of the print logs, it is possible to appropriately prevent an inconsistency from being generated between the print logs at the acquisition server 11 and the printers Pr1 through Prm. Hence, an extremely large amount of print logs can be sent appropriately and positively from the printers Pr1 through Prm to the acquisition server 11.

Moreover, in the print log management system 1 of this embodiment, if the acquisition server 11 issues the print log send request with respect to the printers Pr1 through Prm and the printers Pr1 through Prm sends the print logs in divisions for each send request, the printers Pr1 through Prm may not receive the next send request within a predetermined wait time and may only receive the send request after the predetermined wait time. In this case, the printers Pr1 through Prm restart the sending of the print logs from the start, and execute a resending process that sends the print logs from the start by adding the transfer start information to the print log that is sent in divisions first.

Accordingly, even if an error is generated during the sending of the print logs and the system is restored after the predetermined wait time elapses, it is possible to appropriately prevent an inconsistency from being generated in the print logs between the acquisition server 11 and the printers Pr1 through Prm. Thus, it is possible to more appropriately and positively send an extremely large amount of print logs.

Furthermore, in the print log management system 1 of this embodiment, if the acquisition server 11 issues the print log send request with respect to the printers Pr1 through Prm, the printers Pr1 through Prm send the print logs in divisions for each send request, and the acquisition server 11 starts the acquisition of the print logs, the acquisition server 11 may issue a send request that is added with the start data request information which requests the sending of the print log in divisions from the start and simultaneously clear the memory 53.

Accordingly, even if an error is generated during the sending of the print logs and the system is restored after the predetermined wait time elapses, it is possible to appropriately prevent an inconsistency from being generated in the print logs between the acquisition server 11 and the printers Pr1 through Prm. Thus, it is possible to more appropriately and positively send an extremely large amount of print logs.

In addition, in the print log management system 1 of this embodiment, the printers Pr1 through Prm create a list of the print logs stored in the print log memory 38 when starting the sending of the print logs in divisions, and store the list in the list memory 39 in order to send the print logs in divisions based on the print log list.

Accordingly, during the sending of the print logs in divisions, it is possible to accurately send the target print logs that are to be sent, even if the print logs stored in the print log memory 38 of the printers Pr1 through Prm are changed.

In the print log management system 1 of this embodiment, the printers Pr1 through Prm may send the print logs to the acquisition server 11 by enciphering the print logs by a predetermined enciphering technique. The enciphering itself of the print logs may be made by a known means, and a description thereof will be omitted.

In this case, it is possible to prevent tampering of the print logs.

In the embodiment described above, the print logs are sent from the printers Pr1 through Prm to the acquisition server 11. However, the present invention may be similarly applied to the sending of the print logs from each of the acquisition servers 11 to the central management server 2.

In addition, although the print logs are used in the embodiment as the acquired data, the acquired data that are sent are not limited to the print logs.

The present invention is further applicable to a data acquisition method comprising:

acquiring and storing acquired data in a data acquisition apparatus that includes a storage to store the acquired data and a control unit to send the acquired data that is stored in the storage and is requested by a data acquisition request, by adding transfer information to the acquired data that is sent; and

sending the data acquisition request and managing the acquired data acquired from the data acquisition apparatus via a network by a data management apparatus,

wherein the control unit of the data acquisition apparatus sends the acquired data in divisions if an amount of the acquired data stored in the storage exceeds a predetermined amount, by adding, as the transfer information, transfer start information to the acquired data sent in the divisions first, adding transfer complete information to the acquired data that is sent last in the divisions or, sends the transfer complete information when there is no more unsent acquired data stored within the storage, and adds, as the transfer information, transfer continue information to the acquired data sent in the divisions between the acquired data that are sent first and last. In this case, the data acquisition apparatus and the data management apparatus, that are connected via the network, form the data acquisition system described above.

This application claims the benefit of a Japanese Patent Application No. 2006-334807 filed Dec. 12, 2006, in the Japanese Patent Office, the disclosure of which is hereby incorporated by reference.

Further, the present invention is not limited to these embodiments, but various variations and modifications may be made without departing from the scope of the present invention.

What is claimed is:

1. A data acquisition apparatus, connectable via a network to a data management apparatus, and acquires data requested from the data management apparatus, said data acquisition apparatus comprising:
a storage configured to store the acquired data; and
a control unit configured to send the acquired data that is stored in the storage and is requested by an external data acquisition request by adding transfer information to the acquired data that is sent,
wherein said control unit sends the acquired data in divisions if an amount of the acquired data stored in the storage exceeds a predetermined amount, by adding, as the transfer information, transfer start information to the acquired data sent in the divisions first, and adding transfer complete information to the acquired data that is sent last in the divisions or, sends the transfer complete information when there is no more unsent acquired data stored within the storage.

2. The data acquisition apparatus as claimed in claim 1, wherein said control unit adds, as the transfer information, transfer continue information to the acquired data sent in the divisions between the acquired data that are sent first and last.

3. The data acquisition apparatus as claimed in claim 1, wherein said control unit creates a list of the acquired data stored in the storage.

4. The data acquisition apparatus as claimed in claim 3, wherein the acquired data are logs of processes executed by the data acquisition apparatus.

5. The data acquisition apparatus as claimed in claim 4, wherein the acquired data are print logs related to any one of print, copy, facsimile and scanner functions provided by the data acquisition apparatus.

6. The data acquisition apparatus as claimed in claim 5, wherein the data acquisition apparatus forms a printer.

7. The data acquisition apparatus as claimed in claim 1, wherein the control unit, after receiving a data acquisition request does not receive a next data acquisition request for a predetermined wait time, restarts sending of the acquired data in divisions from the start by adding the transfer start information.

8. A data acquisition system comprising:
a data acquisition apparatus configured to acquire and store acquired data, including a storage to store the acquired data and a control unit to send the acquired data that is stored in the storage and is requested by a data acquisition request, by adding transfer information to the acquired data that is sent; and
a data management apparatus configured to send the data acquisition request and manage the acquired data acquired from the data acquisition apparatus via a network,
wherein the control unit of said data acquisition apparatus sends the acquired data in divisions if an amount of the acquired data stored in the storage exceeds a predetermined amount, by adding, as the transfer information, transfer start information to the acquired data sent in the divisions first, adding transfer complete information to the acquired data that is sent last in the divisions or, sends the transfer complete information when there is no more unsent acquired data stored within the storage, and adds, as the transfer information, transfer continue information to the acquired data sent in the divisions between the acquired data that are sent first and last.

9. The data acquisition system as claimed in claim 8, wherein:
the data management apparatus includes a first memory configured to temporarily store the acquired data, and a second memory configured to store committed acquired data;
the processing unit of the data management apparatus clears the first memory and starts to temporarily store the acquired data that are received into the first memory if the transfer information from the data acquisition apparatus is the transfer start information, temporarily stores the acquired data into the first memory if the transfer information from the data acquisition apparatus is the transfer continue information, and commits the acquired data that are temporarily stored in the first memory and stores the committed acquired data into the second memory if the transfer information from the data acquisition apparatus is the transfer complete information.

10. The data acquisition system as claimed in claim 8, wherein the control unit of the data acquisition apparatus, after receiving a data acquisition request does not receive a next data acquisition request for a predetermined wait time, restarts sending of the acquired data in divisions from the start by adding the transfer start information.

11. The data acquisition system as claimed in claim 9, wherein the data management apparatus, when starting acquisition of the acquired data from the data acquisition apparatus, issues a data acquisition request that is added with start data request information which requests the sending of the acquired data in divisions from the start and simultaneously clears the first memory.

12. The data acquisition system as claimed in claim 8, wherein:
the control unit of the data acquisition apparatus creates a list of the acquired data;
the data acquisition apparatus further includes an other storage configured to store the list; and
the control unit of the data acquisition apparatus sends the acquired data in divisions based on the list stored in the other storage.

13. The data acquisition system as claimed in claim 8, wherein the acquired data are print logs related to any one of print, copy, facsimile and scanner functions provided by the data acquisition apparatus.

14. A computer-readable storage medium which stores a program for causing a computer to function as a data acquisition apparatus that is connectable via a network to a data management apparatus and acquires data requested from the data management apparatus, said program comprising:
a procedure causing the computer to store the acquired data in a storage; and
a control procedure causing the computer to send the acquired data that is stored in the storage and is requested by an external data acquisition request by adding transfer information to the acquired data that is sent,
wherein said control procedure causes the computer to send the acquired data in divisions if an amount of the acquired data stored in the storage exceeds a predetermined amount, by adding, as the transfer information, transfer start information to the acquired data sent in the divisions first, and adding transfer complete information to the acquired data that is sent last in the divisions or, to send the transfer complete information when there is no more unsent acquired data stored within the storage.

15. The computer-readable storage medium as claimed in claim 14, wherein said control procedure causes the computer to add, as the transfer information, transfer continue information to the acquired data sent in the divisions between the acquired data that are sent first and last.

16. The computer-readable storage medium as claimed in claim 14, wherein said control procedure causes the computer to create a list of the acquired data stored in the storage.

17. The computer-readable storage medium as claimed in claim 16, wherein the acquired data are logs of processes executed by the data acquisition apparatus that is formed by the computer.

18. The computer-readable storage medium as claimed in claim 17, wherein the acquired data are print logs related to any one of print, copy, facsimile and scanner functions provided by the data acquisition apparatus that is formed by the computer.

19. The computer-readable storage medium as claimed in claim 18, wherein the data acquisition apparatus forms a printer.

20. The computer-readable storage medium as claimed in claim 14, wherein the control procedure, after receiving a data acquisition request does not receive a next data acquisition request for a predetermined wait time, causes the computer to restart sending of the acquired data in divisions from the start by adding the transfer start information.
